(19) United States
(12) Patent Application Publication
(10) Pub. No.: US 2021/0387472 A1
(43) Pub. Date: Dec. 16, 2021

(54) WHEEL FOR VEHICLE AND METHOD FOR MANUFACTURING WHEEL FOR VEHICLE

(71) Applicant: CENTRAL MOTOR WHEEL CO., LTD., Anjo-shi (JP)

(72) Inventor: Morio SUGANUMA, Toyota-shi (JP)

(73) Assignee: CENTRAL MOTOR WHEEL CO., LTD., Anjo-shi (JP)

(21) Appl. No.: 17/339,342

(22) Filed: Jun. 4, 2021

(30) Foreign Application Priority Data
Jun. 11, 2020 (JP) 2020-101309

(51) Int. Cl. B60B 3/04; B60B 7/06

(52) U.S. Cl. CPC B60B 3/044; B60B 7/063

(57) ABSTRACT

A wheel for a vehicle includes: a wheel rim; a wheel disc; and a laser-welded portion made by joining the wheel rim and the wheel disc by laser welding. In a circumferential direction of the wheel, a total length of the laser-welded portion is equal to or more than 90% of a length of an entire circumference of the wheel disc. The wheel has, between the wheel rim and the wheel disc, at least one non-welded point at which the laser-welded portion is not provided in the circumferential direction of the wheel.

### CROSS-REFERENCE TO RELATED APPLICATION

This application claims priority to Japanese Patent Application No. 2020-101309 filed on Jun. 11, 2020, incorporated herein by reference in its entirety.

### BACKGROUND

### 1. Technical Field

Techniques disclosed herein relate to a wheel for a vehicle and a method for manufacturing a wheel for a vehicle.

### 2. Description of Related Art

Some wheels for a vehicle include a wheel rim having a generally cylindrical shape and a wheel disc having a generally disc shape and fitted to an inner periphery of the wheel rim. As a wheel for a vehicle of this type, a wheel for a vehicle is known that is made by joining a wheel rim and a wheel disc by arc welding. In arc welding, the amount of heat input per unit area is relatively large. Therefore, with an excessive amount of heat input, thermal strain and residual stress tend to occur in the wheel for a vehicle to cause deformation. For this reason, in a wheel for a vehicle that is made by joining by arc welding, the length of the welded portion in the circumferential direction of the wheel for a vehicle generally is equal to or less than 60% of the length of the entire circumference of the wheel disc.

In contrast, a wheel for a vehicle is known that is made by joining a wheel rim and a wheel disc by laser welding (see, for example, Japanese Unexamined Patent Application Publication No. 5-329671 (JP 5-329671 A)). In laser welding, the wheel rim and the wheel disc can be joined with a smaller amount of heat input than in arc welding. That is, in laser welding, the fatigue strength is improved because the wheel rim and the wheel disc are less thermally deformed than in arc welding. Therefore, the fitting length between the wheel rim and the wheel disc that is required to secure the fatigue strength can be shortened. As a result, in laser welding, it is possible to achieve improvement in the dimensional accuracy and the weight reduction of the wheel for a vehicle. Thus, in some wheels for a vehicle that are made by joining by laser welding, the wheel rim and the wheel disc are joined by performing laser welding over the entire circumference of the wheel disc or more.

### SUMMARY

However, in a conventional wheel for a vehicle in which laser welding is performed over the entire circumference of the wheel disc or more, for example, the durability of the wheel for a vehicle may decrease due to presence of an excessive heat input point in the laser-welded portion. The excessive heat input point is a point at which a large amount of heat input is supplied as compared with other points in the laser-welded portion. When laser welding is performed over the entire circumference of the wheel disc or more, the start and end points of the laser welding overlap or are brought to be adjacent to each other. Therefore, overlapping or adjacent points are supplied with about twice as much heat as other points, thereby becoming the excessive heat input points.

Note that among the wheels for a vehicle made by joining by laser welding, there is a wheel for a vehicle that has a welded portion with a length of 60% or less of the entire circumference of the wheel disc, similarly to the wheel for a vehicle made by joining by arc welding. However, in such a wheel for a vehicle, the non-welded point having no laser-welded portion is relatively long. Therefore, the joint strength (durability (fatigue strength), breaking strength) of the wheel for a vehicle may decrease.

The present specification discloses techniques capable of solving at least a part of the above-mentioned problems.

The techniques disclosed herein can be realized in the following aspects.

A first aspect of the present disclosure relates to a wheel for a vehicle. The wheel includes: a wheel rim having a generally cylindrical shape; a wheel disc having a generally disc shape and fitted to an inner periphery of the wheel rim; and a laser-welded portion made by joining the wheel rim and the wheel disc by laser welding. In a circumferential direction of the wheel, a total length of the laser-welded portion is equal to or more than 90% of a length of an entire circumference of the wheel disc. The wheel has, between the wheel rim and the wheel disc, at least one non-welded point at which the laser-welded portion is not provided in the circumferential direction of the wheel.

In the wheel for a vehicle of the above aspect, there is the non-welded point at which a laser-welded portion is not provided in the circumferential direction between the wheel rim and the wheel disc. Therefore, formation of the excessive heat input point is suppressed, as compared with the configuration in which there is no non-welded point. Further, in the wheel for a vehicle of the above aspect, in the circumferential direction of the wheel for a vehicle, the total length of the laser-welded portion is equal to or more than 90% of the length of the entire circumference of the wheel disc. Therefore, a decrease in joint strength of the wheel for a vehicle can be suppressed, as compared with the configuration in which the total length of the laser-welded portion is less than 90% of the length of the entire circumference of the wheel disc for example. That is, with the wheel for a vehicle of the above aspect, it is possible to suppress a decrease in durability due to the excessive heat input point while suppressing a decrease in joint strength.

In the above aspect, a length of the non-welded point in the circumferential direction may be 2 mm or more. The wheel for a vehicle of the above aspect facilitates visual recognition of presence or absence of the non-welded point, as compared with the configuration in which the length of the non-welded point in the circumferential direction is less than 2 mm. Moreover, the wheel for a vehicle can suppress the formation of the excessive heat input point more effectively.

In the above aspect, the wheel may have only one non-welded point between the wheel rim and the wheel disc. In the wheel for a vehicle of the above aspect, the length of the laser-welded portion is longer than that in the configuration in which there is a plurality of non-welded points between the wheel rim and the wheel disc by an amount corresponding to the length over which the laser-welded portion continues, and the joint strength between the wheel rim and the wheel disc can be improved accordingly.

In the above aspect, a length of the non-welded point in the circumferential direction may be 5 mm or less. With the wheel for a vehicle of the above aspect, a decrease in joint strength due to the presence of the non-welded points can be suppressed, as compared with the configuration in which the length of each non-welded point in the wheel circumferential direction is more than 5 mm.

In the above aspect, the wheel may have a plurality of the non-welded points between the wheel rim and the wheel disc, and the non-welded points may be arranged at equal intervals in the circumferential direction. With the wheel for a vehicle, the running stability of the wheel for a vehicle can be improved as compared with the configuration in which a plurality of non-welded points are arranged at unequal intervals.

A second aspect of the present disclosure relates to a method for manufacturing a wheel for a vehicle, in which the wheel includes a wheel rim having a generally cylindrical shape and a wheel disc having a generally disc shape and disposed on an inner peripheral side of the wheel rim. The method includes: a preparation step of preparing a composite body in which the wheel disc is disposed inside the wheel rim; and a laser welding step of joining an inner peripheral surface of the wheel rim and an outer peripheral surface of the wheel disc in the composite body by laser welding. In the laser welding step, laser welding is performed such that a total length of a laser-welded portion in a circumferential direction of the wheel is equal to or more than 90% of a length of an entire circumference of the wheel disc and the wheel has, between the wheel rim and the wheel disc, at least one non-welded point at which the laser-welded portion is not provided in the circumferential direction of the wheel. According to the method for manufacturing a wheel for a vehicle, it is possible to manufacture a wheel for a vehicle in which a decrease in durability due to an excessive heat input point is suppressed and a decrease in joint strength is also suppressed.

The techniques disclosed in the present specification can be realized in various forms, for example, a wheel for a vehicle, a method for manufacturing a wheel for a vehicle, and the like.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an XZ plan view schematically showing an appearance configuration of a front side of a steel wheel 100 in a first embodiment;

FIG. 2 is an explanatory view showing a part of a manufacturing process of the steel wheel 100;

FIG. 3 is an XZ plan view schematically showing an appearance configuration of a back side of the steel wheel 100;

FIG. 4 is a flowchart showing a part of a method for manufacturing the steel wheel 100; and

FIG. 5 is an XZ plan view schematically showing an appearance configuration of a back side of a steel wheel 100a in a second embodiment.

### DETAILED DESCRIPTION OF EMBODIMENTS

### First Embodiment

Configuration of Steel Wheel 100 for Vehicle

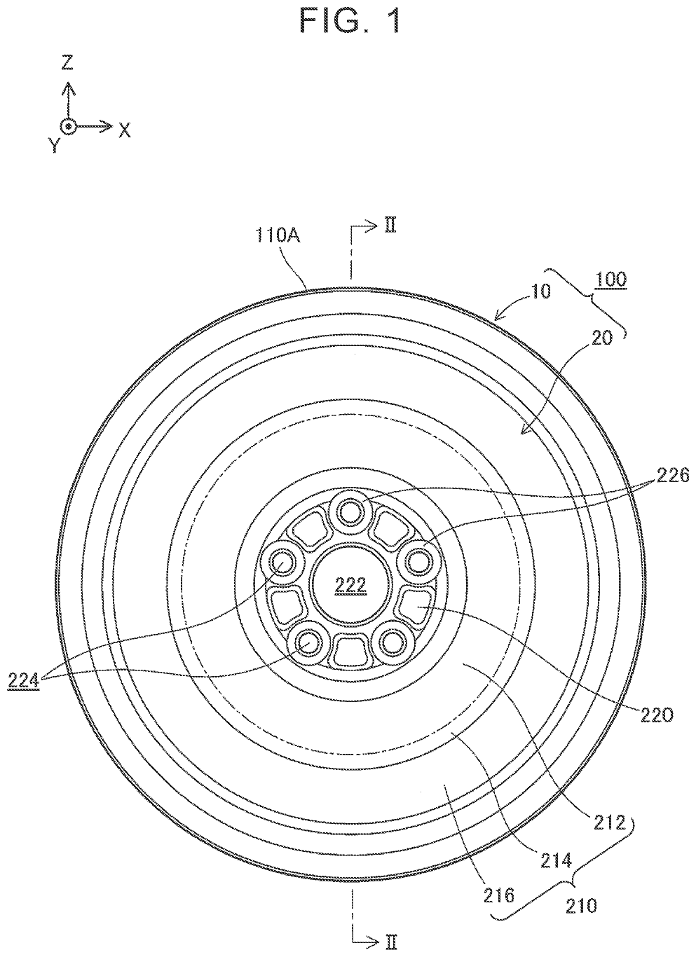

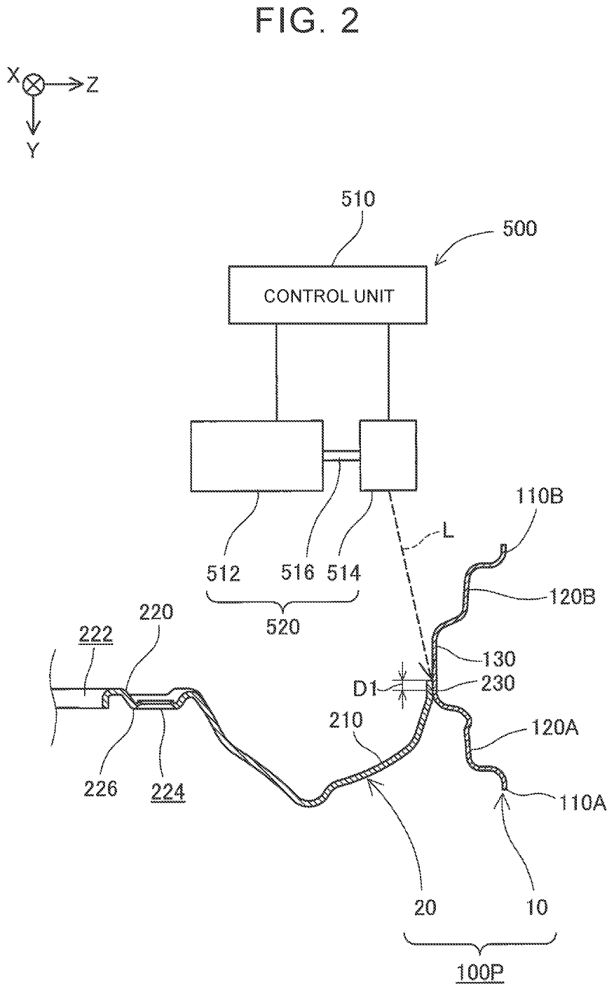

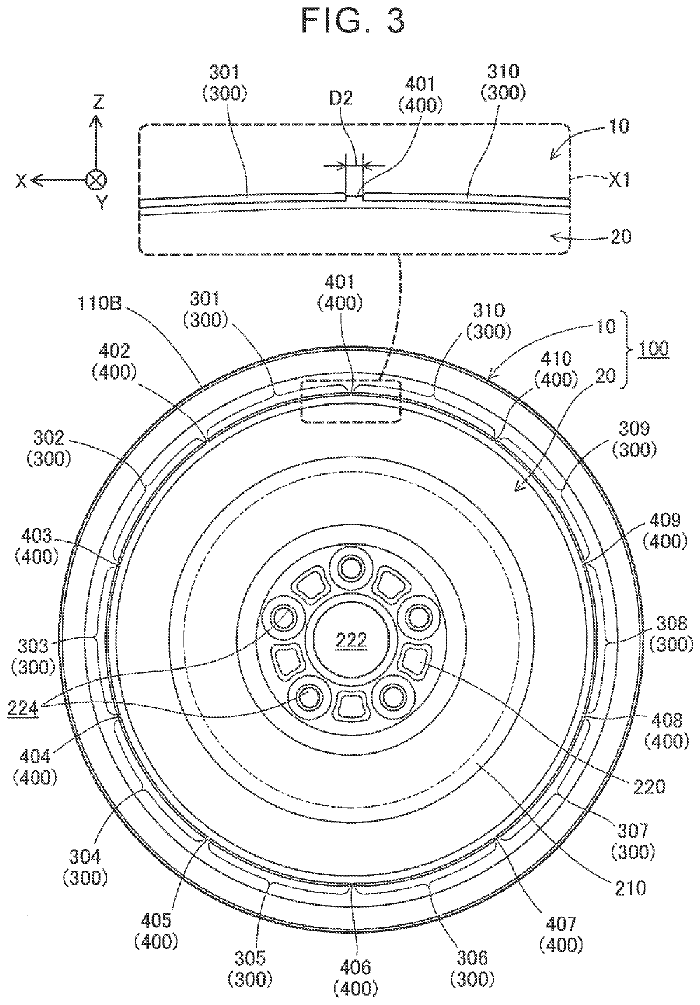

FIG. 1 is an XZ plan view schematically showing an appearance configuration of a front side of a steel wheel for a vehicle (hereinafter, referred to as “steel wheel”) 100 according to the present embodiment, and FIG. 2 is an explanatory view showing a part of a manufacturing process of the steel wheel 100. FIG. 2 shows a laser welding apparatus 500 and a part of the steel wheel 100, and the part of the steel wheel 100 is shown as a YZ sectional configuration at a position II-II of FIG. 1. Each drawing shows X, Y, Z-axes that are orthogonal to each other to identify the directions. In the present specification, the Y-axis direction is assumed to be a direction parallel to the rotation axis of the steel wheel 100, for convenience, and is hereinafter referred to as “wheel axial direction”, but the steel wheel 100 may actually be disposed to face in a direction that is different from such a direction. Further, the radial direction of the steel wheel 100 is referred to as “wheel radial direction”, and the circumferential direction about the rotation axis of the steel wheel 100 is referred to as “wheel circumferential direction”. The same applies to FIG. 3 and subsequent drawings. The steel wheel 100 is an example of a wheel for a vehicle in claims.

The steel wheel 100 includes a wheel rim 10 having a generally cylindrical shape, a wheel disc 20 having a generally disc shape and fitted to an inner periphery of the wheel rim 10, and laser-welded portions 300 (see FIG. 3 described later) made by joining the wheel rim 10 and the wheel disc 20 by laser welding. The steel wheel 100 of the present embodiment is a so-called two-piece steel wheel in which the wheel rim 10 and the wheel disc 20 are separate members. Hereinafter, one side of the steel wheel 100 in the wheel axial direction (the front surface side of the steel wheel 100, Y-axis positive side) will be referred to as “outer side”, and the other side in the wheel axis direction (the back surface side of the steel wheel 100, Y-axis negative side) will be referred to as “inner side”. When the steel wheel 100 is mounted on a vehicle body (not shown), the outer side of the steel wheel 100 faces to the side opposite from the vehicle body, and the inner side of the steel wheel 100 faces to the vehicle body side. A surface of the steel wheel 100 on the outer side is regarded as a design surface.

### Wheel Rim 10

As shown in FIG. 2, the wheel rim 10 includes a pair of flange portions 110A and 110B, a pair of bead seat portions 120A and 120B, and a drop portion 130.

The flange portions 110A and 110B each have a generally annular shape as seen in the wheel axial direction (Y-axis direction), and are located at opposite ends of the wheel rim 10 in the wheel axial direction. The flange portions 110A and 110B hold a tire (not shown) mounted on the steel wheel 100 such that the tire would not be displaced in the wheel axial direction.

The bead seat portions 120A and 120B are arranged between the flange portions 110A and 110B in the wheel axial direction (Y-axis direction). Specifically, the bead seat portion 120A on the outer side is disposed on the inner side of the flange portion 110A on the outer side so as to be adjacent to the flange portion 110A. The bead seat portion 120B on the inner side is disposed on the outer side of the flange portion 110B on the inner side so as to be adjacent to the flange portion 110B. Each of the bead seat portions 120A and 120B has an outer peripheral surface that is substantially parallel to the wheel axial direction, and the tire is supported by the contact of a bead portion of the tire with the outer peripheral surfaces.

The drop portion 130 is disposed between the bead seat portions 120A and 120B in the wheel axial direction (Y-axis direction). The drop portion 130 has a shape recessed inward in the wheel radial direction from the bead seat portions 120A and 120B as seen in the wheel circumferential direction. This provides a groove (drop well) on the outer periphery of the drop portion 130. The groove is provided in the wheel rim 10, so that the tire can be easily attached to and detached from the steel wheel 100.

### Wheel Disc 20

As shown in FIGS. 1 and 2, the wheel disc 20 includes a hat portion 210, a hub mounting portion 220, and a disc flange portion 230.

The hub mounting portion 220 has a generally disc shape, and is located substantially at the center of the wheel disc 20 as seen in the wheel axial direction (Y-axis direction). A hub hole 222 to which a hub (not shown) of the vehicle body is connected is provided at substantially the center of the hub mounting portion 220. Further, around the hub hole 222, a plurality of (five in FIG. 1) seat surface portions 226 is provided such that the seat surface portions 226 are arranged at equal intervals in the wheel circumferential direction (see FIG. 1).

Each seat surface portion 226 is provided with a bolt hole 224 passing therethrough, in which a fastening member (not shown) is inserted. Specifically, in the present embodiment, the bolt hole 224 of the seat surface portion 226 is opened such that the diameter thereof increases toward the outer side. Further, each seat surface portion 226 has a shape that the peripheral portion of the bolt hole 224 projects toward the outer side. Specifically, the peripheral portion of the seat surface portion 226 is inclined such that the diameter thereof increases toward the inner side.

In the present embodiment, the fastening member has a configuration including: a nut member disposed on the outer side of the bolt hole 224 in the steel wheel 100 and having an internal thread; and a serration bolt disposed on the inner side of the bolt hole 224 in the steel wheel 100 and having an external thread, for example. The fastening member may have a configuration including: a hub bolt disposed on the outer side of the bolt hole 224 in the steel wheel 100 and having an external thread and a seat surface; and a hub having an internal thread. Further, the fastening member may have another fastening structure (press-fitting structure, and the like) instead of screw members such as a nut member and a bolt.

The outer peripheral surface of the peripheral portion of the bolt hole 224 in each seat surface portion 226 is a tapered surface with its outer diameter decreasing toward the bolt hole 224. When the hub mounting portion 220 is connected to the vehicle body by fastening with the fastening member, a part of the fastening member (for example, the head of the bolt or the nut) is seated in the peripheral portion of the bolt hole 224 in the seat surface portion 226.

The disc flange portion 230 has a generally annular shape as seen in the wheel axial direction (Y-axis direction), and is located on the outer peripheral edge side of the wheel disc 20. The outer peripheral surface of the disc flange portion 230 is fitted to the inner peripheral surface of the drop portion 130 of the wheel rim 10 (see FIG. 2). Hereinafter, the length of the part where the wheel rim 10 and the wheel disc 20 are fitted (disc flange portion 230) in the wheel axial direction will be referred to as “fitting length D1” of the wheel rim 10 and the wheel disc 20.

The hat portion 210 is an annular portion that is located between the hub mounting portion 220 and the disc flange portion 230 and that surrounds the hub mounting portion 220, as seen in the wheel axial direction (Y-axis direction). The hat portion 210 is raised toward the outer side. Specifically, the hat portion 210 includes an inner peripheral portion 212, an apex portion 214, and an outer peripheral portion 216. The apex portion 214 has a generally annular shape as seen in the wheel axial direction, and is located on the outer side of the hub mounting portion 220 and the disc flange portion 230 in the wheel axial direction. The inner peripheral portion 212 has a generally annular shape and is located on the inner peripheral side of the apex portion 214 as seen in the wheel axial direction. Further, the inner peripheral portion 212 is a portion that is inclined so as to be raised outward from the outer peripheral edge of the hub mounting portion 220 toward the apex portion 214. The outer peripheral portion 216 has a generally annular shape and is located on the outer peripheral side of the apex portion 214 as seen in the wheel axial direction. Further, the outer peripheral portion 216 is a portion that is inclined so as to be raised outward from the disc flange portion 230 toward the apex portion 214.

### Laser-Welded Portion 300

The wheel disc 20 is disposed at a position toward the outer side of the wheel rim 10. The outer peripheral surface of the wheel disc 20 (disc flange portion 230) is fitted to the inner peripheral surface of the drop portion 130 of the wheel rim 10 and the outer peripheral surface of the wheel disc 20 and the inner peripheral surface of the drop portion 130 are joined by laser welding (for example, fillet welding by irradiating a portion near the boundary between the wheel rim 10 and the wheel disc 20 with laser light L). As a result, the laser-welded portions 300 are formed between the wheel rim 10 and the wheel disc 20 (see FIG. 3 described later). The detailed configuration of the laser-welded portion 300 will be described below.

### Detailed Configuration of Laser-Welded Portion 300

FIG. 3 is an XZ plan view schematically showing the appearance configuration of the back side (inner side) of the steel wheel 100. FIG. 3 shows an enlarged view of the configuration of a portion X1 of the steel wheel 100. In FIG. 3, the laser-welded portions 300 (welding marks) are provided between the wheel rim 10 and the wheel disc 20 on the inner side of the steel wheel 100 so as to be visually recognizable.

As shown in FIG. 3, in the steel wheel 100, the total length of the laser-welded portions 300 in the wheel circumferential direction is equal to or more than 90% of the length of the entire circumference of the wheel disc 20, and there is a plurality of non-welded points 400 between the wheel rim 10 and the wheel disc 20. The non-welded points 400 are points at which the laser-welded portion 300 is not provided in the wheel circumferential direction (gaps). That is, at the non-welded points 400, the wheel rim 10 and the wheel disc 20 are not joined by laser welding, and there is no welding mark. When there is only one non-welded point 400, the total length of the laser welded portion 300 is the entire length of the one laser-welded portion 300, and when there is a plurality of non-welded points 400, the total length of the laser-welded portions 300 is a total of the lengths of the laser-welded portions 300.

The steel wheel 100 further satisfies the following first requirement in terms of the laser-welded portions 300.

### First Requirement

A length D2 of each non-welded point 400 on the steel wheel 100 in the wheel circumferential direction is 2 mm or more.

The steel wheel 100 further satisfies the following second requirement in terms of the laser-welded portions 300.

### Second Requirement

The length D2 of each non-welded point 400 on the steel wheel 100 in the wheel circumferential direction is 5 mm or less.

The steel wheel 100 further satisfies the following third requirement in terms of the laser-welded portions 300.

### Third Requirement

There is the plurality of non-welded points 400 between the wheel rim 10 and the wheel disc 20, and the non-welded points 400 are arranged at equal intervals in the wheel circumferential direction.

Specifically, as shown in FIG. 3, the steel wheel 100 includes 10 laser-welded portions 300 (301 to 310) arranged in the wheel circumferential direction. The laser-welded portions 300 adjacent to each other in the wheel circumferential direction are separated from each other, and the non-welded point 400 (gap) is provided between the laser-welded portions 300.

The fitting length D1 of the wheel rim 10 and the wheel disc 20 is 4 mm or more and 5 mm or less, and the length D2 of each non-welded point 400 in the wheel circumferential direction is equal to or less than the fitting length D1. The length D2 of each non-welded point 400 in the wheel circumferential direction is 2 mm or more and 5 mm or less. The lengths of the 10 laser-welded portions 300 (301 to 310) in the wheel circumferential direction are all the same. Here, the wording “the lengths of the laser-welded portions 300 are the same” means that errors in the lengths of the laser-welded portions 300 are ±5 mm or less. The 10 laser-welded portions 300 are arranged at equal intervals in the wheel circumferential direction, and the 10 non-welded points 400 are arranged at equal intervals in the wheel circumferential direction. The length D2 of each non-welded point 400 in the wheel circumferential direction is shorter than the length of each laser-welded portion 300 in the wheel circumferential direction. The total length of the laser-welded portions 300 in the wheel circumferential direction (when there is a plurality of laser-welded portions 300, the total of the lengths of the laser-welded portions 300) is preferably equal to or more than 95% of the length of the entire circumference of the wheel disc 20.

In the steel wheel 100, the length D2 of each non-welded point 400 in the wheel circumferential direction can be set to be equal to or less than the fitting length D1 of the wheel rim 10 and the wheel disc 20. Therefore, a decrease in durability (fatigue strength) of the steel wheel 100 can be more effectively suppressed, as compared with a configuration in which the length D2 of the non-welded point 400 is longer than the fitting length D1, for example. Further, there is the plurality of non-welded points 400 between the wheel rim 10 and the wheel disc 20, and the length D2 of each non-welded point 400 in the wheel circumferential direction is shorter than both of the lengths, in the wheel circumferential direction, of the pair of laser-welded portions 300 located on the opposite sides of the non-welded point 400. Thus, according to the present embodiment, a decrease in joint strength (durability, breaking strength) due to the presence of the non-welded points 400 can be suppressed, as compared with the configuration in which the length D2 of each non-welded point 400 in the wheel circumferential direction is longer than the length, in the wheel circumferential direction, of at least one of the laser-welded portions 300 located on the opposite sides of the non-welded point 400.

### Method for Manufacturing Steel Wheel 100

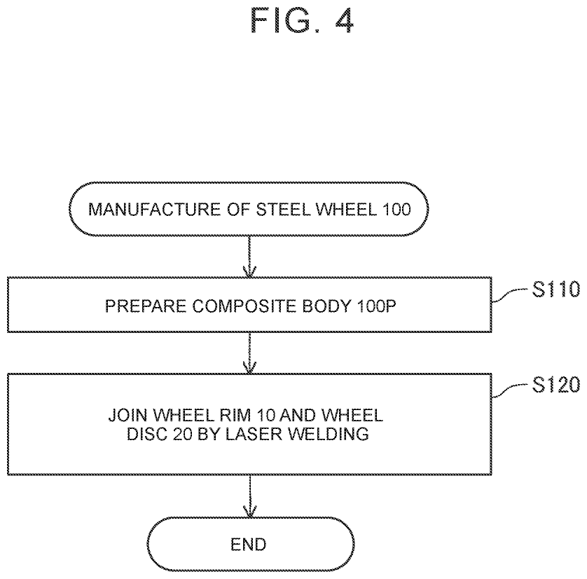

Next, a method for manufacturing the steel wheel 100 will be described. FIG. 4 is a flowchart showing a part of the method for manufacturing the steel wheel 100. As shown in FIG. 4, first, a preparation step of preparing a composite body 100P (see FIG. 2) is performed (S110). The composite body 100P is a body in which the wheel disc 20 is fitted to the inner periphery of the wheel rim 10 but the wheel disc 20 and the wheel rim 10 have not been joined by laser welding yet. The wheel rim 10 can be manufactured, for example, by molding a steel flat plate. The wheel disc 20 can be manufactured, for example, by molding a steel flat plate.

Next, a laser welding step of joining the inner peripheral surface of the wheel rim 10 and the outer peripheral surface of the wheel disc 20 by laser welding is performed (S120). Specifically, for example, the laser welding apparatus 500 includes a control unit 510 and a laser processing unit 520. The control unit 510 includes a central processing unit (CPU) and a memory (not shown), and controls the operation of the laser processing unit 520. The laser processing unit 520 is, for example, of a head-separated type that a body portion 512 and a head portion 514 are connected to each other via an optical fiber 516. The body portion 512 is provided with a laser light source such as an yttrium aluminum garnet (YAG) laser oscillator and a carbon gas laser oscillator. The head portion 514 is connected to the body portion 512 via the optical fiber 516 and is rotatable with respect to the body portion 512. The laser light L emitted from the laser light source of the head portion 514 is transmitted to the head portion 514 via the optical fiber 516, and is projected from the head portion 514 onto a point to be welded in the composite body 100P.

As shown in FIG. 2, the composite body 100P is held by a holding device (not shown) with its inner side facing upward, and is rotated about a wheel axis, for example. The laser welding apparatus 500 is located above the composite body 100P, and the laser light L from the head portion 514 is projected onto a portion near the boundary between the wheel rim 10 and the wheel disc 20 on the inner side of the steel wheel 100. That is, by the control of the control unit 510, laser welding is performed such that the total length of the laser-welded portions 300 in the wheel circumferential direction corresponds to 90% or more of the length of the entire circumference of the wheel disc 20 and there is the plurality of non-welded points 400 between the wheel rim 10 and the wheel disc 20. Accordingly, the wheel rim 10 and the wheel disc 20 are joined by laser welding, and the steel wheel 100 is thus manufactured.

### Effects of Present Embodiment

As described above, in the steel wheel 100 according to the present embodiment, the total length of the laser-welded portions 300 in the wheel circumferential direction is equal to or more than 90% of the length of the entire circumference of the wheel disc 20. Therefore, a decrease in joint strength of the steel wheel 100 can be suppressed, as compared with the configuration in which the total length of the laser-welded portions 300 is less than 90% of the length of the entire circumference of the wheel disc 20, for example. Of the joint strength, the breaking strength is a load that acts when the laser-welded portions 300 or other parts break in the case where the wheel rim 10 is fixed and a force is applied to the wheel disc 20 in the wheel axial direction. In the present embodiment, there are non-welded points 400 in the wheel circumferential direction between the wheel rim 10 and the wheel disc 20. Therefore, the formation of the excessive heat input point is suppressed, as compared with the configuration in which there is no non-welded point 400. That is, according to the present embodiment, it is possible to suppress a decrease in durability due to the excessive heat input point while suppressing a decrease in joint strength. The durability herein means the durability evaluated by the radial load durability test specified in JIS D 4103.

In particular, in the steel wheel 100 of the present embodiment, the fitting length D1 is relatively short (for example, 5 mm or less) in order to reduce the weight. Accordingly, the contact area between the wheel rim 10 and the wheel disc 20 is relatively narrow. Thus, if each non-welded point 400 is excessively long, there may be a case that a sufficient joint strength between the wheel rim 10 and the wheel disc 20 cannot be secured. In contrast, in the present embodiment, since the length of each non-welded point 400 is equal to or less than the fitting length D1, it is possible to suppress a decrease in joint strength between the wheel rim 10 and the wheel disc 20.

In the present embodiment, the length D2 of each non-welded point 400 on the steel wheel 100 in the wheel circumferential direction is 2 mm or more (first requirement). Thereby, according to the present embodiment, the formation of the excessive heat input point can be more effectively suppressed, as compared with the configuration in which the length of each non-welded point 400 in the wheel circumferential direction is less than 2 mm. Further, in the quality inspection after manufacture of the steel wheel 100, it becomes easy to visually recognize the presence or absence of the non-welded points 400. Therefore, it is possible to sort out defective steel wheels 100 based on the visual recognition of the presence or absence of the non-welded points 400 by humans, without using a special inspection device.

In the present embodiment, the length D2 of each non-welded point 400 on the steel wheel 100 in the wheel circumferential direction is 5 mm or less (second requirement). Thereby, according to the present embodiment, a decrease in joint strength due to the presence of the non-welded points 400 can be suppressed, as compared with the configuration in which the length of each non-welded point 400 in the wheel circumferential direction is more than 5 mm.

In the present embodiment, there is the plurality of non-welded points 400 between the wheel rim 10 and the wheel disc 20, and the non-welded points 400 are arranged at equal intervals in the wheel circumferential direction (third requirement). Thereby, according to the present embodiment, the running stability and the operation stability of the steel wheel 100 can be improved, as compared with the configuration in which the non-welded points 400 are arranged at unequal intervals.

### Second Embodiment

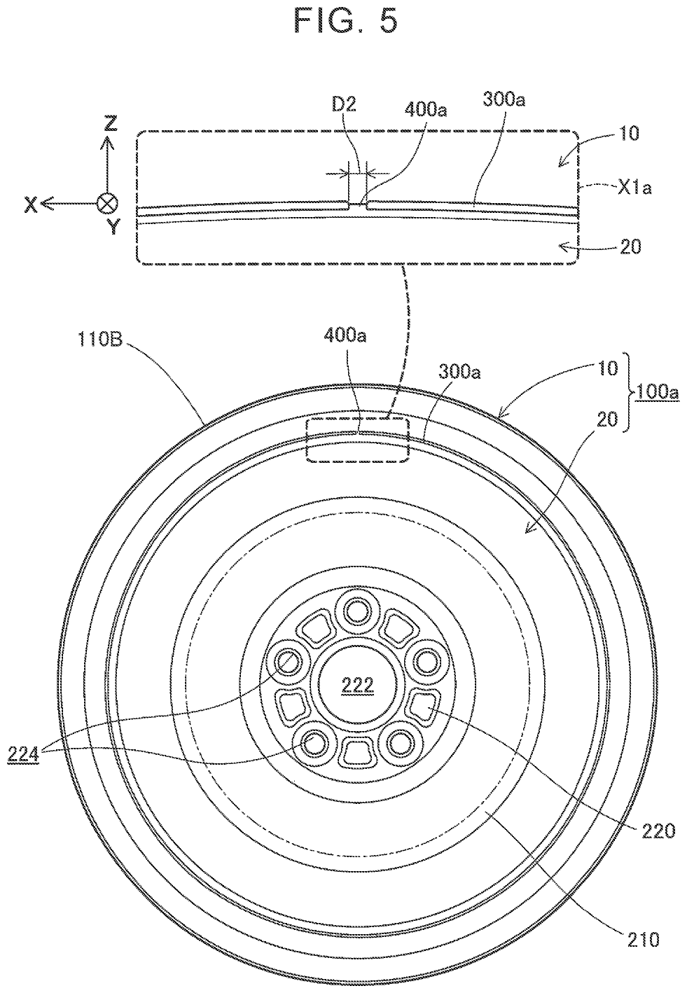

FIG. 5 is an XZ plan view schematically showing the appearance configuration of the back side of a steel wheel 100a in the second embodiment. In the following, the same components as those of the steel wheel 100 in the first embodiment, out of the components of the steel wheel 100a of the second embodiment, are denoted by the same reference signs and description thereof will be appropriately omitted.

As shown in FIG. 5, in the steel wheel 100a, there is only one non-welded point 400a. In the wheel circumferential direction, the total length of the laser-welded portion 300a is equal to or more than 99% of the length of the entire circumference of the wheel disc 20. The length of the laser-welded portion 300a is longer than that in the configuration in which there is a plurality of non-welded points 400a between the wheel rim 10 and the wheel disc 20 by an amount corresponding to the length over which the laser-welded portion 300a continues, and the joint strength between the wheel rim 10 and the wheel disc 20 can be improved accordingly. The length D2 of one non-welded point 400a on the steel wheel 100a in the wheel circumferential direction is preferably 2 mm or more, and preferably 5 mm or less.

### Modifications

The techniques disclosed in the present specification are not limited to the above-described embodiments, and can be modified into various forms without departing from the scope thereof. For example, the following modifications are also possible.

The configuration of the steel wheel 100 in the above embodiment is merely an example, and can be modified in various ways. For example, in the above embodiment, the laser-welded portion 300 is formed by fillet welding. However, the laser-welded portion 300 may be formed by lap welding, for example, in which welding is performed by irradiating the outer peripheral surface of the drop portion 130 of the wheel rim 10 with the laser light L. Further, the laser-welded portion 300 may have a configuration that does not satisfy at least one of the above first to third requirements. For example, the steel wheel 100 may have a configuration in which there is one or a plurality of (for example, one, two or more, four or more, six or more, eight or more) non-welded points 400 other than 10 points.

Further, the laser-welded portion 300 may have a configuration in which the length D2 of at least one non-welded point 400 in the wheel circumferential direction is less than 2 mm or more than 5 mm.

In the above embodiment, the two-piece steel wheel 100 has been exemplified as the wheel for a vehicle, but the present disclosure is not limited to this. For example, the wheel for a vehicle may be a so-called three-piece wheel including a wheel rim composed of two parts, namely, an outer rim and an inner rim, and a wheel disc, or may be a wheel other than the steel wheel (for example, an aluminum wheel).

The method for manufacturing the steel wheel 100 in the above embodiment is merely an example, and can be modified in various ways. For example, in the laser welding step (S120) of the above embodiment, the laser-welded portion 300 is formed by fillet welding. However, for example, the laser-welded portion 300 may be formed by lap welding.

What is claimed is:

1. A wheel for a vehicle, the wheel comprising:
a wheel rim having a generally cylindrical shape;
a wheel disc having a generally disc shape and fitted to an inner periphery of the wheel rim; and
a laser-welded portion made by joining the wheel rim and the wheel disc by laser welding, wherein:
in a circumferential direction of the wheel, a total length of the laser-welded portion is equal to or more than 90% of a length of an entire circumference of the wheel disc; and
the wheel has, between the wheel rim and the wheel disc, at least one non-welded point at which the laser-welded portion is not provided in the circumferential direction of the wheel.

2. The wheel according to claim 1, wherein a length of the non-welded point in the circumferential direction is 2 mm or more.

3. The wheel according to claim 1, wherein the wheel has only one non-welded point between the wheel rim and the wheel disc.

4. The wheel according to claim 1, wherein a length of the non-welded point in the circumferential direction is 5 mm or less.

5. The wheel according to claim 1, wherein:
the wheel has a plurality of the non-welded points between the wheel rim and the wheel disc; and
the non-welded points are arranged at equal intervals in the circumferential direction.

6. A method for manufacturing a wheel for a vehicle, the wheel including a wheel rim having a generally cylindrical shape and a wheel disc having a generally disc shape and disposed on an inner peripheral side of the wheel rim, the method comprising:
a preparation step of preparing a composite body in which the wheel disc is disposed inside the wheel rim; and
a laser welding step of joining an inner peripheral surface of the wheel rim and an outer peripheral surface of the wheel disc in the composite body by laser welding, wherein in the laser welding step, laser welding is performed such that a total length of a laser-welded portion in a circumferential direction of the wheel is equal to or more than 90% of a length of an entire circumference of the wheel disc and the wheel has, between the wheel rim and the wheel disc, at least one non-welded point at which the laser-welded portion is not provided in the circumferential direction of the wheel.
